(19) United States
(12) Patent Application Publication
(10) Pub. No.: US 2002/0047093 A1
(43) Pub. Date: Apr. 25, 2002

(54) Method of capturing scanning electron microscope images and scanning electron microscope apparatus for performing the method

(76) Inventors: Ki-Jung Son, Suwon-city (KR); Yong-Hyeon Kim, Osan-city (KR)

Correspondence Address: JONES VOLENTINE, L.L.C., Suite 150, 12200 Sunrise Valley Drive, Reston, VA, 20191, US

(21) Appl. No.: 09/983,416

(22) Filed: Oct. 24, 2001

(30) Foreign Application Priority Data
Oct. 24, 2000 (KR) 00-62609
Jun. 1, 2001 (KR) 01-30773

(51) Int. Cl. G21K 7/00; G01N 23/00

(52) U.S. Cl. 250/307; 250/311

(57) ABSTRACT

A method of capturing scanning electron microscope (SEM) images of a sample, such as a photo mask, and a scanning electron microscope (SEM) apparatus capable of executing the method are provided. The method of capturing SEM images includes steps of intentionally electrically charging the surface of the sample, and subsequently scanning the charged surface of the sample with a primary electron beam. An ionizer or an electron gun may be used to charge the surface of the sample. Once the surface is charged to a predetermined level, the charges (ions or electrons) distribute themselves uniformly on the surface of the sample. Thus, the primary electrons will not be deflected by electrical attraction or repulsion as the electrons near the surface of the sample. Accordingly, the present invention facilitates the initial focusing of the primary electron beam on a desired spot on the sample, and reduces the number of occurrences and durations of pattern shifting phenomena.

### BACKGROUND OF THE INVENTION

1. Field of the Invention

The present invention relates to a scanning electron microscope (SEM). More particularly, the present invention relates to a method of, and to an SEM apparatus for, capturing images of the surface of a photo mask used in the process of manufacturing semiconductor devices.

2. Description of the Related Art

A scanning electron microscope (SEM) is used to analyze the process of manufacturing semiconductor devices. For example, an SEM is used to capture images of the surface of a sample of the device and, from such images, measure a critical dimension (CD) of a pattern formed at the surface of the sample.

In a well-known technique using an SEM, the surface of a sample is scanned with a primary electron beam, and secondary electrons emitted from the surface of the sample are detected and converted into a signal. Images of the surface of the sample are produced from this signal. Because the SEM uses an electron beam, the electrical state of, namely the level and distribution of electrons on the surface of the sample affects the images captured by the SEM.

A method of grounding the surface of the sample using a gold coating has been suggested as a means of countering the effects that the level of electric charge at the surface of the sample would otherwise have on the SEM images. However, it is difficult to coat a sample of a semiconductor device with gold in the laboratory and still leave the sample to be photographed functional as intended. Also, a method of grounding the sample using a simple ground pin has been suggested. However, such a method will not produce the desired grounding in the case where an insulator or a conductor isolated by an insulator forms the surface of the sample.

An example of such a case is a photo mask used in semiconductor device manufacturing. The photo mask is an opaque pattern formed of chrome, for example, on a quartz substrate as isolated or insulated by the quartz substrate. Thus, the chrome pattern can not be directly grounded. Accordingly, it is very difficult to capture SEM images of the surface of the photo mask. For example, it is difficult to initially focus the primary electron beam on the surface of the photo mask, or the images captured by the SEM have defects such as batter or pattern shifting.

### SUMMARY OF THE INVENTION

Therefore, it is an object of the present invention to solve the above-described problems of the prior art method of capturing scanning electron microscope images of the surface of a sample formed of an insulator or a conductor isolated by an insulator.

More specifically, an object of the present invention is to provide a method of capturing scanning electron microscope images in which it is easy to initially focus the primary beam of electrons on a desired spot on the surface of sample formed of an insulator or a conductor isolated by an insulator, and in which no pattern shifting of the image occurs or such pattern shifting is alleviated in a short period of time.

To achieve the above objects, the present invention provides a method of capturing scanning electron microscope (SEM) images in which the surface of the sample is intentionally electrically charged before the scanning of the sample with the primary electron beam begins. The intentional charging of the surface of the sample is performed using an ionizer or an electron gun.

The charging of the surface of the sample increases the uniformity of the distribution of electric charge on the surface of the sample. Accordingly, when scanning begins, the electrons of the primary beam will not be deflected as they approach the surface of the sample. Thus, they will impinge the sample at the intended spot, i.e., the spot at which the electrons were focused.

It is still another object of the present invention to provide an SEM apparatus capable of executing the above-described method.

To achieve this object, the present invention provides a scanning electron microscope (SEM) apparatus that includes both an image photographing unit for photographing the surface of the sample using a scanning electron beam, and a sample processing unit for intentionally electrically charging the surface of the sample before the sample is provided to the image photographing unit. The image photographing unit scans the surface of a sample with a primary electron beam, captures secondary electrons generated by the bombardment of the surface with the electron beam, produces a signal from the secondary electrons, and processes the signal into an image of the surface.

The sample processing unit includes either an ionizer for directing ions onto the surface of the sample or an electron gun for directing electrons onto the surface of the sample.

According to the present invention, defects in initial focusing and a pattern shift phenomenon during SEM photographing are suppressed, so that stable SEM images can be captured quickly.

### BRIEF DESCRIPTION OF THE DRAWINGS

The above and other objects, features and advantages of the present invention will become more apparent by referring to the following detailed description of the preferred embodiments thereof made with reference to the attached drawings, of which:

FIG. 1 is a schematic diagram of a scanning electron microscope (SEM) apparatus for capturing electron microscope images according to the present invention;

FIG. 2 is a schematic diagram of a sample mounted to a sample holder, the sample having a photo mask whose image is captured according to the present invention;

FIG. 3 is a schematic diagram of an ionizer of the SEM apparatus of the present invention;

FIGS. 4 through 5 are sectional views of a sample, schematically illustrating the diffraction of incident electrons due to respective non-uniform distributions of charge at the surface of the sample;

FIG. 6 is a sectional view of a sample, schematically illustrating the charging of the sample and the path of incident electrons according to the method of the present invention;

FIG. 7 is a scanning electron microscope (SEM) photo of the surface of a photo mask after the photo mask is intentionally charged according to the method of the present invention;

FIG. 8 is a scanning electron microscope (SEM) photo of the surface of a grounded photo mask, in comparison with the method of the present invention;

FIG. 9 is a map of the surface of a simply grounded photo mask, illustrating the durations and drift directions of pattern shift phenomena at nine points on the surface of the grounded photo mask;

FIG. 10 is a map of the surface of a photo mask whose surface has been intentionally charged according to the method of the present invention, illustrating the durations and drift directions of pattern shift phenomena at the same nine points on the surface of the photo mask;

FIG. 11 illustrates graph of measurements of critical dimensions (CD) of a 0.92 μm chrome pattern from SEM photos taken when the chrome pattern is not charged and when the chrome pattern is intentionally charged according to the present invention;

FIG. 12 is a schematic diagram of a first embodiment of an SEM apparatus according to the present invention;

FIG. 13 is a schematic diagram of another embodiment of an SEM apparatus according to the present invention;

FIG. 14 is a schematic diagram illustrating a photo mask and a sample holder according to an embodiment of the present invention;

FIG. 15 is a diagram of measured points for measuring effects in a state where the surface of the photo mask according to an embodiment of the present invention is not grounded;

FIGS. 16 through 19 are SEM photos captured from the points of FIG. 15 in the case where a ground pin is used; and

FIGS. 20 through 23 are SEM photos captured from the points of FIG. 15 in the case where a ground pin is insulated from the surface of the photo mask.

### DETAILED DESCRIPTION OF THE PREFERRED EMBODIMENTS

The present invention will be described more fully hereinafter with reference to the accompanying drawings. In the drawings, various elements are exaggerated for the sake of clarity. Furthermore, the same reference numerals designate like elements throughout the drawings.

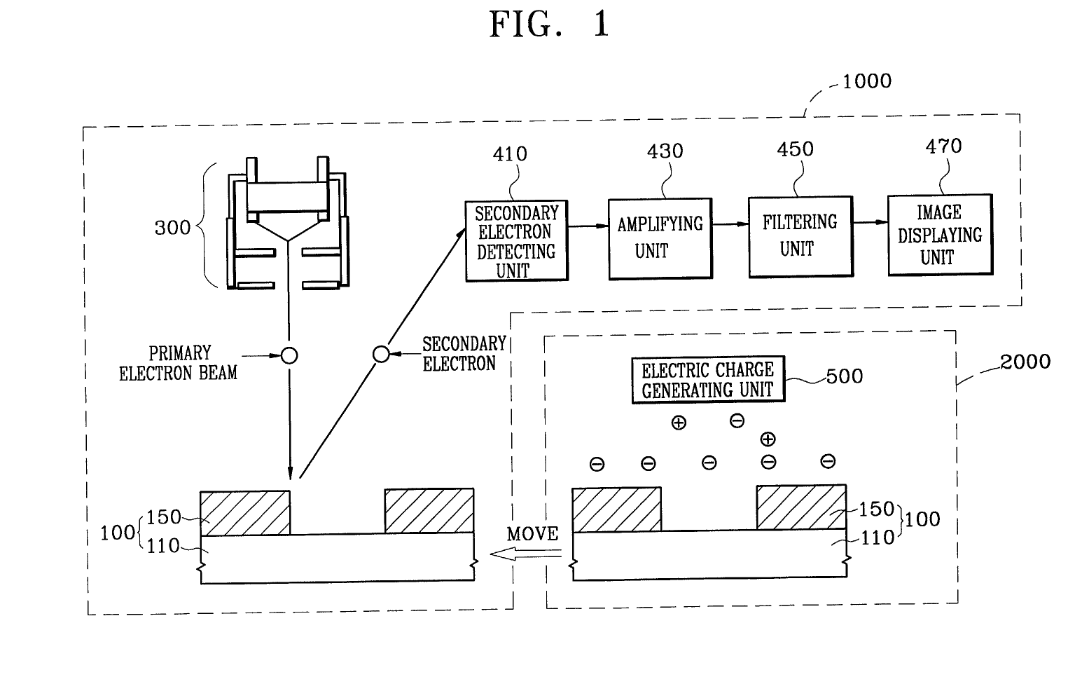

Referring to FIG. 1, in the method of the present invention, the surface of a sample 100 is intentionally charged before the surface is photographed by a scanning electron microscope (SEM). The sample 100 comprises a photo mask, e.g. a chrome pattern 150, formed on a quartz substrate 110. The chrome pattern exposes portions of the surface of the quartz substrate 110. Thus, the surface of the sample 100 is constituted by the exposed portions of the quartz substrate 110 and the conductive chrome pattern 150 isolated by the exposed quartz substrate 110.

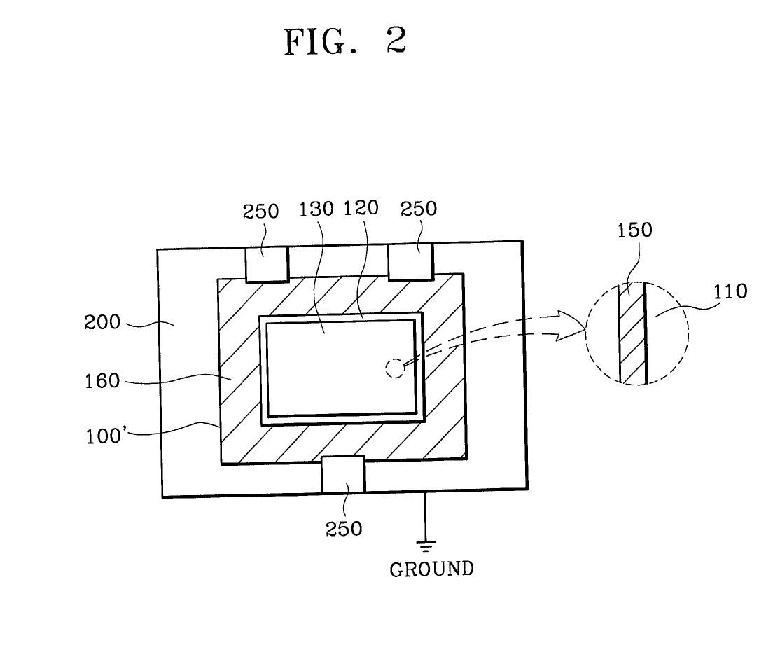

As shown in FIG. 2, a photo mask includes a circumferential region 160 and a pattern region 130 constituted by a chrome layer deposited on the quartz substrate 110. The chrome layer that is located in the pattern region 130 is patterned using photolithography to thereby form the chrome pattern 150. The remainder of the chrome layer remains in the circumference region 160.

The portion of the chrome layer in the circumference region 160 is separated or isolated from the chrome pattern 150 by a separation region 120. The separation region 120 is formed of a portion of the exposed quartz substrate 110. That is, the chrome layer occupying the circumference region 160 is not electrically connected to the chrome pattern 150 occupying the pattern region 130.

When a conventional photo mask is mounted to a sample holder 200 in preparation for the SEM photographing of the photo mask, ground pins 250 contact the photo mask 100′. Specifically, the ground pins 250 electrically connect the circumference region 160 to ground. However, the chrome pattern 150 is not electrically grounded by the ground pins 250 because the pattern region 130 is electrically insulated from the circumference region 160.

Static electricity or plasma used in the previous process may leave electric charge on the surface of the photo mask. However, such electric charge will not distribute itself uniformly over the surface of the photo mask, and the non-uniform distribution of electric charge has a disadvantageous effect on the SEM photographing of the surface of the sample 100′.

Moreover, as discussed above, the electric charge on the surface of the sample 100′, particularly, on the pattern region 130 of the photo mask, can not be eliminated by simple ground pins. And, the surface of the photo mask cannot be grounded by a conventional method of forming a gold coating as a ground layer because the photo mask is to be used in the semiconductor device manufacturing process.

Thus, when SEM images are taken by scanning the surface of the grounded photo mask with a primary electron beam, the non-uniform distribution of electric charge on the surface of the photo mask makes it is difficult to perform an initial focusing. Furthermore, even when the SEM images can be taken, the images displayed on an image display unit (470 of FIG. 1), e.g. a monitor, show drift with respect to the initial spot on which the SEM was focused. That is, a pattern shift phenomenon can occur in which the images captured on the screen are actually of a spot on the surface of the sample 100′ other than that on which the SEM is focused.

And so, as it stands now, as the primary electron beam is initially scanned along the surface of the sample 100′, it is difficult to overcome a noise or pattern shifting phenomenon produced due to the initial non-uniform distribution of electrons on the surface of the sample 100′. The problems associated with the noise phenomenon or the pattern shift phenomenon are known to be alleviated when some electrons have accumulated by happenstance on the surface of the sample. However, the inventor has determined that this unintended process must be allowed to proceed for several minutes before the pattern shift phenomenon disappears and the images become stable. This initialization time would prove to be a large burden on the efficiency of semiconductor device manufacturing process. For example, as occasion demands, images must be captured at about 99 spots on the photo mask to facilitate an adequate inspecting the photo mask. Thus, the total initialization time required to alleviate the noise phenomenon and avoid the production of defective images in just one inspecting process would be several hours.

Thus, according to the present invention, the surface of the sample is charged through a dedicated, i.e., intentional, process, to provide the surface with a certain polarity before the SEM photographing begins. The charging of the surface is designed to remove the imbalance in the levels of electric charge on the surface of the sample.

Referring back to FIG. 1, an SEM apparatus for carrying out the method of capturing scanning electron microscope images according to the present invention includes an image photographing unit 1000 and a sample processing unit 2000. The image photographing unit 1000 comprises a well-known structure of an SEM apparatus. For example, the image photographing unit 1000 includes an electron beam column unit 300 for scanning a sample 100 in a vacuum chamber (not shown) with a primary electron beam, a secondary electron detecting unit 410 for detecting secondary electrons emitted from the surface of the sample 100, an amplifying unit 430 for amplifying a detected signal, a filtering unit 450 for filtering the amplified signal, and an image displaying unit 470, e.g., a monitor, for displaying images resulting from the processing of the filtered signal.

On the other hand, the sample processing unit 2000 includes an electric charge generating unit 500 for generating electric charge or electrically charged particles. For example, the electric charge generating unit 500 may be a well-known ionizer for generating ions or an electric gun.

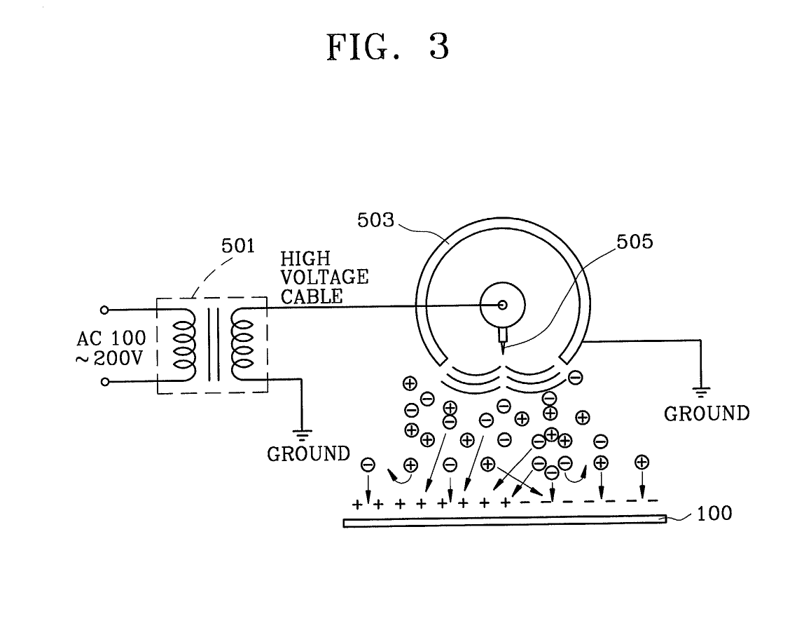

Referring to FIG. 3, the ionizer includes a needle-shaped emitter electrode 505, and an input power supply 501 connected to the emitter electrode 505 so as to produce a high voltage that forms an electric field around the needle-shaped emitter electrode 505. The ionizer also includes a ground electrode 503 extending part way around the emitter electrode 505. Gas molecules around the emitter electrode 505, for example, air molecules, are ionized by the electric field formed around the emitter electrode 505, whereupon a cloud of cations and anions are formed in the vicinity of the sample 100.

The ionizer adjusts the amount of electric charge on the surface of the sample 100. That is, the ionizer directs a certain amount of the ions onto the sample 100 until the surface of the sample 100 attains a balanced electric charge level of, for example, about −10V. The degree to which the surface of the sample 100 is charge by the ionizer is checked by an electrostatic field meter, again, well-known per se. The electrostatic field meter uses a non-contact method to macroscopically measure the charge at the surface of the sample 100.

Referring back to FIG. 1, when the electric charge generating unit 500 comprises the ionizer, the electric charge generating unit 500 is disposed outside the chamber of the image photographing unit 1000 in which the sample 1000 is photographed. However, the electric charge generating unit 500 is connected to the chamber of the image photographing unit 1000.

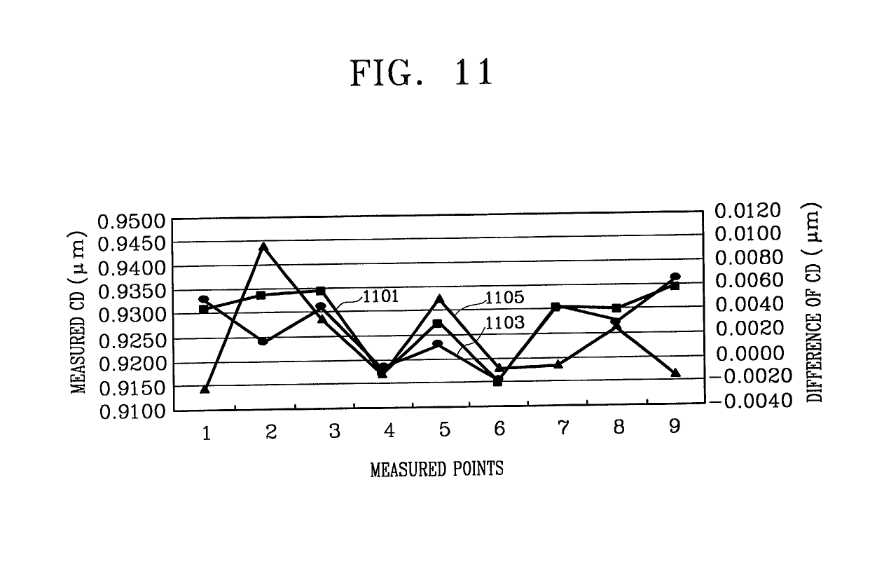

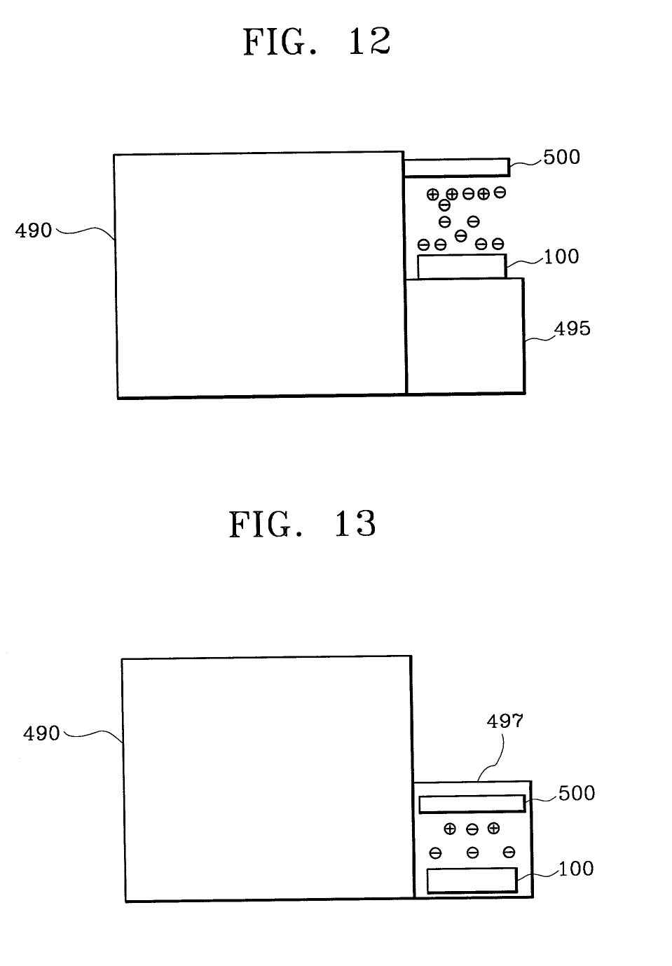

Referring to FIG. 12, reference numeral 490 designates the chamber of the image photographing unit. The electric charge generating unit 500 may be disposed over a loader 495 connected to the chamber 490. the loader 495 is operative to load a sample 100 into the chamber 490 after the surface of the sample is intentionally charged by the ionizer of the electric charge generating unit 500.

Alternatively, as shown in FIG. 13, the electric charge generating unit 500 may be disposed in an auxiliary chamber 497. In this case, the electric charge generating unit 500 comprise an electron gun instead of an the ionizer.

In the case in which an electron gun is used, the surface of the sample 100 is scanned with an electron beam generated by the electron gun. Consequently, electrons accumulate on the surface of the sample 100. These electrons produce an effect similar to those produced when negative ions are directed onto the surface of the sample 100 using the ionizer. That is, the surface of the sample 100 can be intentionally charged to a certain level. An advantage of the ionizer is that the surface of the sample 100 can be charged with a negative polarity or with a positive polarity as occasion demands.

Now, as has been previously alluded to in general terms, the levels of charge on the surface of the sample affects the images captured by the SEM. specifically, when the distribution of the electric charge on the surface of the sample 100 is non-uniform, the primary electrons transmitted by the SEM apparatus are deflected as they approach the surface of the sample.

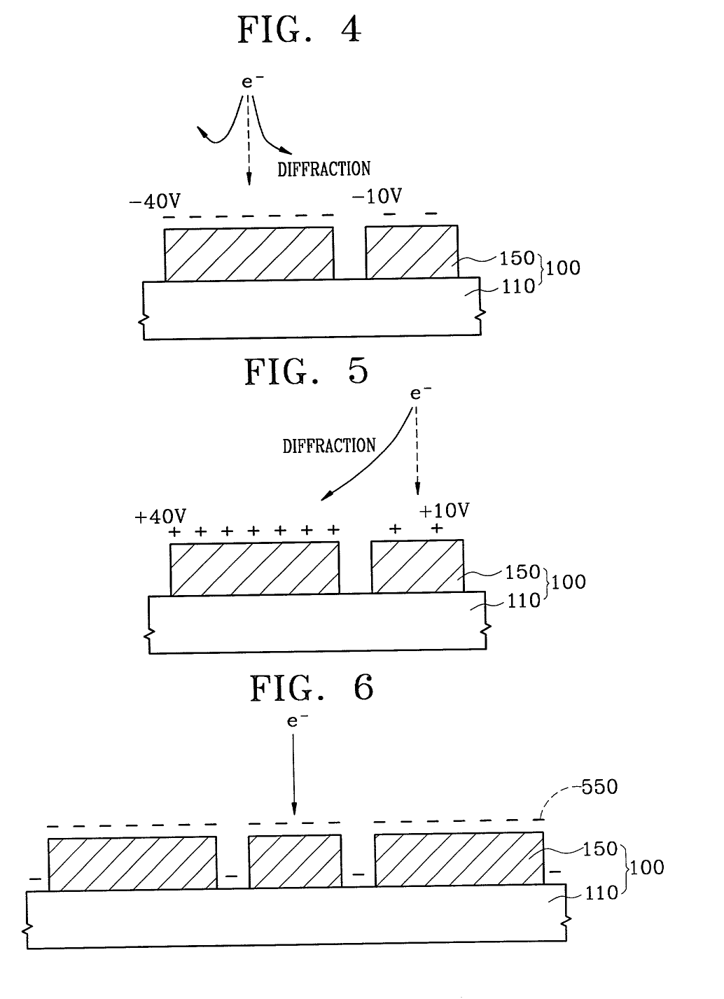

For instance, FIG. 4 illustrates the diffraction of a transmitted electron e⁻ in a case in which two regions on the surface of the sample 100 are charged at −40V and −10V, respectively. FIG. 5 illustrates the defection of a transmitted electron e⁻ in a case in which two regions of the surface of the sample 100 are charged at +40V and +10V, respectively. The deflecting of the primary electrons as they approach the intended spot at which they were focused adversely affects the images captured by the SEM, for obvious reasons.

The charging of the surface of the sample 100 to a certain electric charge level makes the electric charge distribution at the surface of the sample 100 uniform. Therefore, and referring to FIG. 6, in the case in which the electric charge generating unit 500 makes the distribution of electric charge 550 on the surface of the sample 100 uniform, e.g, at about a −270V, the primary electron e⁻ is transmitted to the surface of the sample 100 without being deflected. Thus, the primary electron e⁻ impinges the intended point on the surface of the sample 100, producing a secondary electron from that point to that will yield an accurate depiction of the image of that point on the surface of the sample 100.

The effects of balancing the charge on the surface of the sample 100 according to the present invention will be described in more detail below.

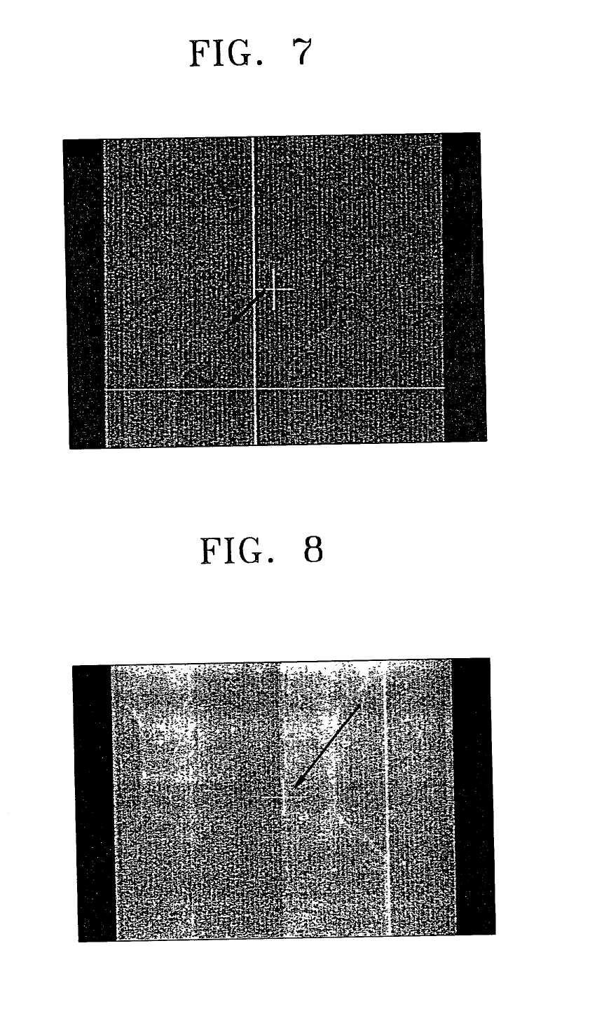

FIG. 7 is a SEM photo taken after the distribution of electric charge on the surface of the photo mask has been charged to about −270V using the ionizer according to the present invention The level of the charge on the surface of the photo mask was confirmed using an electrostatic field meter. In the process in which the photo of FIG. 7 was taken, a pattern shift, i.e., the phenomenon of the image drifting, abated about 15 seconds after the surface was scanned with the primary electron beam.

FIG. 8 is a SEM photo taken after the photo mask was grounded using a sample holder 200 of the type shown in FIG. 2. In the process in which the photo of FIG. 8 was taken, the pattern shift but not until about 165 seconds after the surface of the sample had been scanned with the primary electron beam. The arrows in the drawings denote directions of the pattern shifts.

These results prove that defects in capturing an image, such as the image drift phenomenon that occurs at the beginning of the SEM photo process, can be prevented by charging the surface of the sample 100 to a level at which the charges distribute themselves uniformly across the surface.

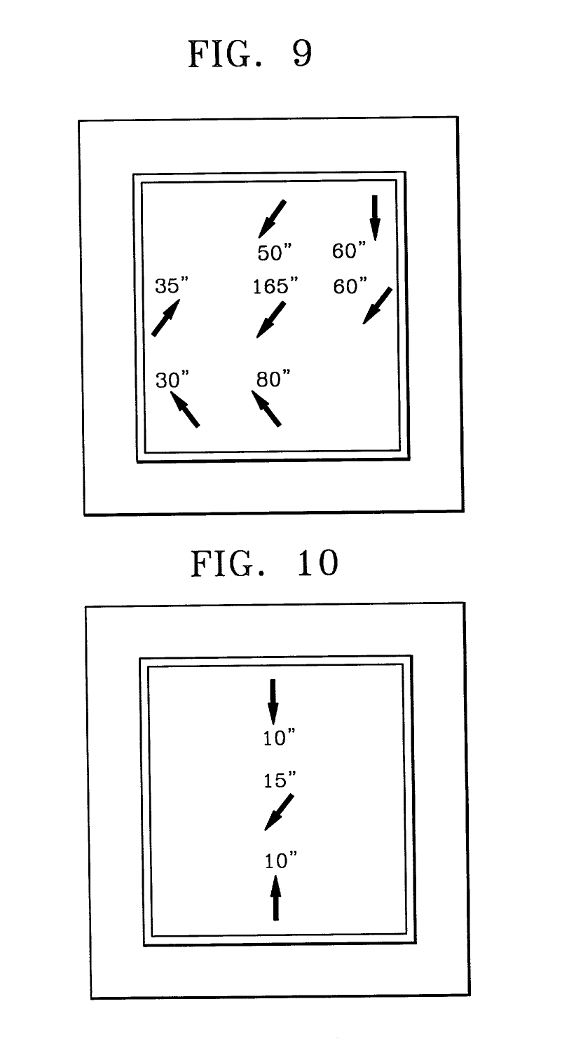

FIG. 9 illustrates the pattern shift phenomenon measured when taking the photograph, shown in FIG. 8, at nine arbitrary points in the pattern region 130 of the surface of the simply grounded photo mask. FIG. 10 illustrates the pattern shift phenomenon measured at the same nine points when taking the photo, shown in FIG. 7, according to the present invention. In these drawings, the arrows show the drift directions at the various points where the pattern shift phenomenon occurred The times in seconds required for the phenomena to abate are shown next to the arrows.

The results shown that the present invention, in which the surface of the photo mask is charged before the SEM photos are taken, yields fewer occurrences of the pattern shift phenomena compared to the case in which the surface of the photo mask is grounded. The results also show that the durations of the pattern shift phenomena are shorter when the present invention is practiced in comparison, again, to the case in which the surface of the photo mask is grounded.

Next, FIG. 11, is a graph of measurements of the critical dimensions (CD) of a chrome pattern of about 0.92 μm taken from SEM photos at the nine points in the pattern region (130 of FIG. 2) of the photo mask.

In the graph of FIG. 11, reference numeral 1101 designates the plot of the CDs of the chrome pattern measured from an SEM photo in the case in which the surface of the photo mask is not charged. Reference numeral 1103 designates the plot of the CDs of the chrome pattern measured from an SEM photo in the case in which the surface of the photo mask is intentionally charged according to the present invention. Reference numeral 1105 designates a plot that illustrates the difference between the two plots 1101 and 1103.

The results of FIG. 11 show that the CDs of the pattern can be measured accurately from the SEM images captured according to the present invention. In addition, the line width of the portions of the quartz substrate exposed by the chrome pattern can also be measured accurately.

Meanwhile, as shown in FIG. 2, when a sample, for example, the photo mask 100′, is put on the sample holder 200 of the SEM apparatus, the photo mask 100′ is generally grounded by the ground pin 250. However, as described previously, when the surface of the photo mask 100′ is intentionally charged-up, a portion of the photo mask 100′ contacting the ground pin 250, that is, the circumference region 160, is electrically grounded by the ground pin 250, and thus electric charge on the surface of the circumference region 160 is grounded at an external area of the photo mask 100′and eliminated. Thus, even if electric charge is intentionally charged-up on the entire surface of the photo mask 100′, electric charge does not accumulate at the surface of the portion contacted by the ground pin 250. That is, the electric charge level on the surface of the circumference region 160 contacting the ground pin 250 is 0V.

This phenomenon can influence the balance of electric charge on the surface of the photo mask 100′ to be uneven. That is, the portion which is grounded by the ground pin 250 and has a surface electric charge level of 0V, has an electric potential difference between other adjacent portions having the intentionally charged-up surface electric charge level, and the balance of electric charge in the adjacent portions is not maintained by induced electrification caused by the electric potential difference. As a result, the entire surface of the photo mask 100′ may be unintentionally charged-up at the balanced surface electric charge level.

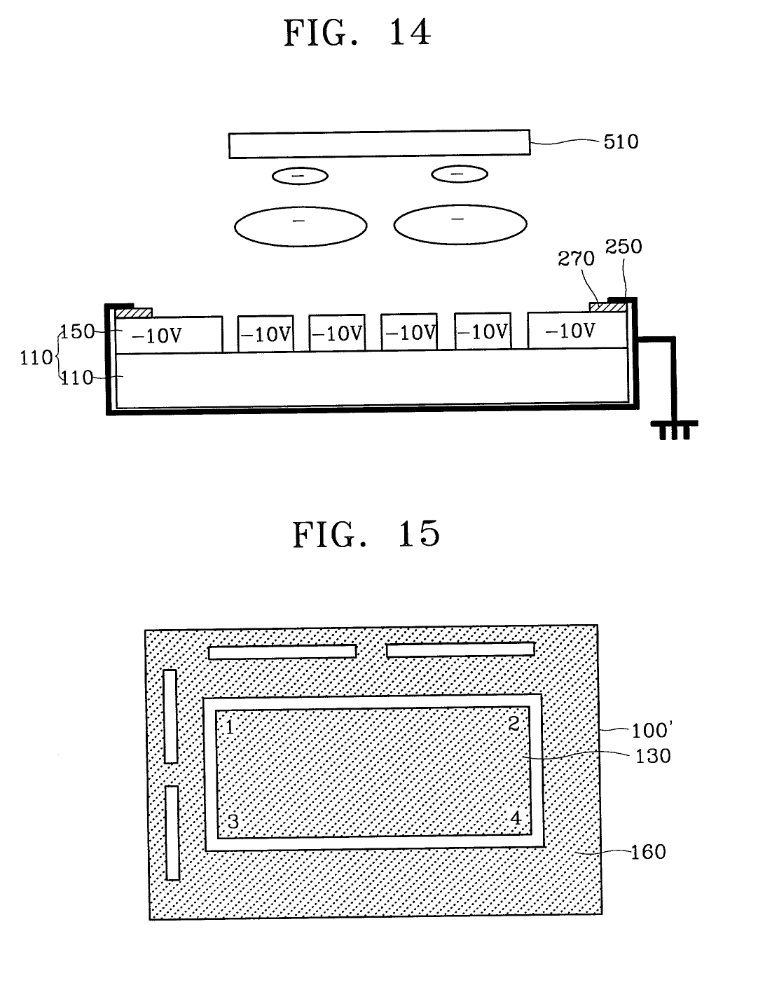

FIG. 14 is a schematic diagram illustrating a photo mask and a sample holder that are insulated according to an embodiment of the present invention.

In order to prevent an unbalance phenomenon of the undesired surface electric charge level, when a sample, that is, a photo mask 100′ is put on a sample holder 200 and is fixed by a pin 250, the pin 250 is substantially insulated from the surface of the photo mask 100′. That is, the pin 250 and the chrome pattern 150 are insulated by providing an insulator 270 between the pin 250 and a chrome pattern 150 so that the surface of the photo mask 100′ is not grounded by the sample holder 200.

As a result, when the surface of the photo mask 100′ is intentionally charged-up by an ionizer 510, chrome patterns 270 can be intentionally charged-up at the same electric charge levels, for example, at −10V. As this happens, diffraction or dispersion of an electron beam, which occur when uneven electric charge levels are formed on the entire surface of the photo mask 100′, can be prevented and SEM images are thereby captured. Thus, a pattern shift phenomenon or defects in focusing that occur on the chrome patterns 270, which are formed on the circumference region of the photo mask 100′, can be prevented, and thus, a good SEM photo may be captured effectively.

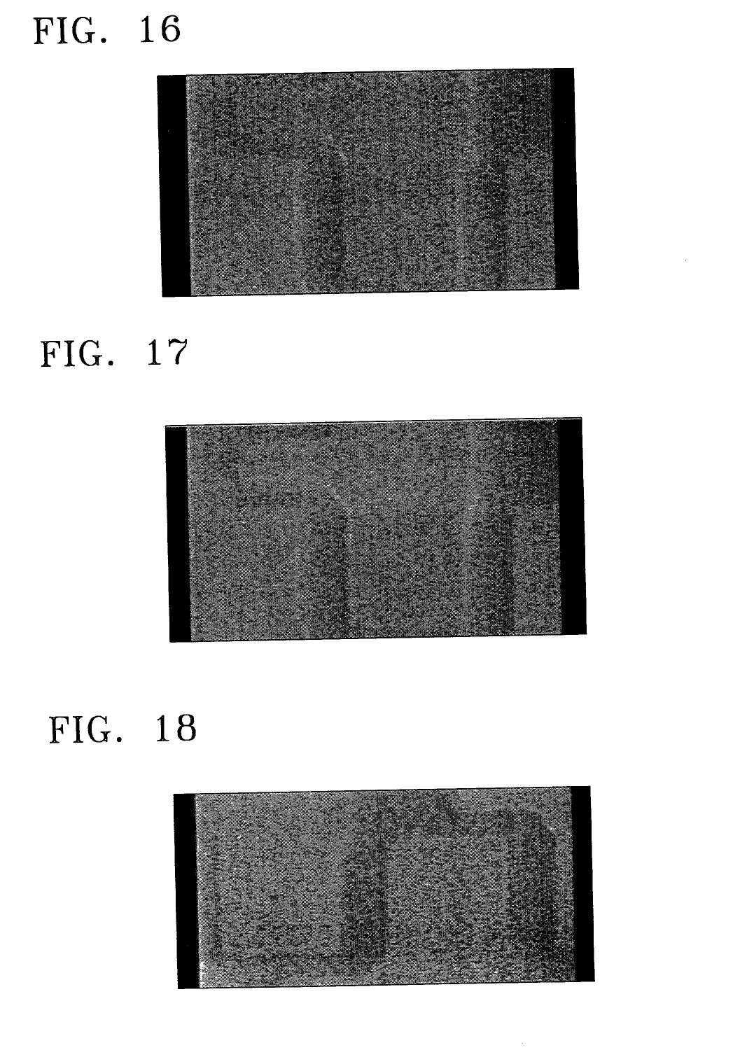

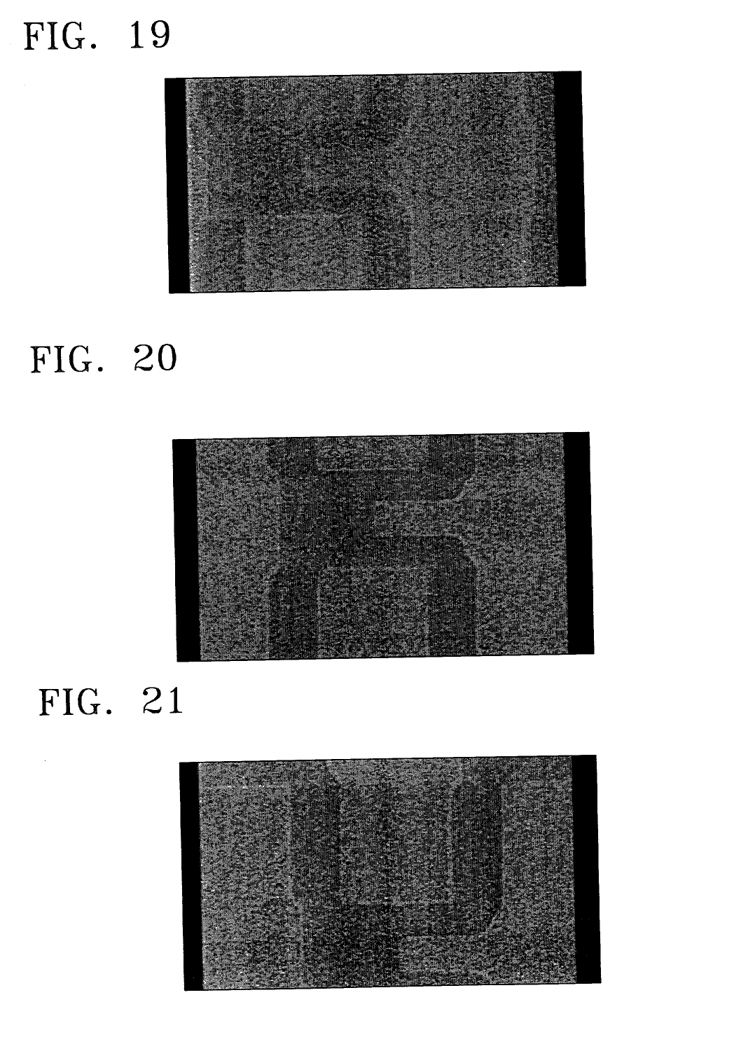

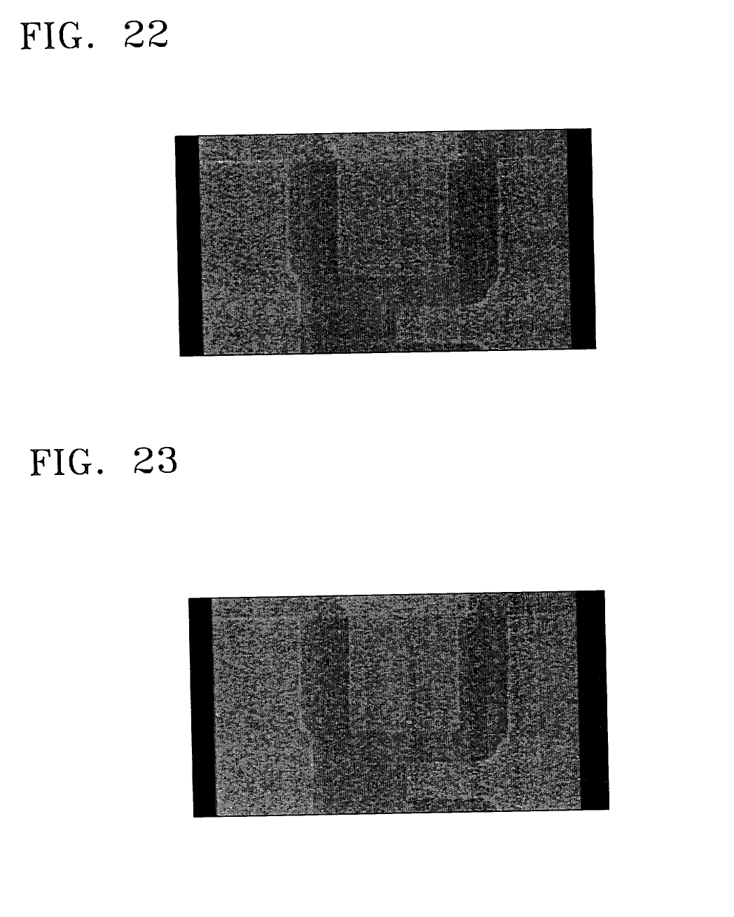

FIG. 15 is a diagram of measured points for measuring effects in a state where the surface of the photo mask is not grounded, according to an embodiment of the present invention. FIGS. 16 through 19 are SEM photos captured from the points of FIG. 15 in the case where the ground pin is used. FIGS. 20 through 23 are SEM photos captured from the points of FIG. 15 in the case where the ground pin is insulated from the surface of the photo mask, according to an embodiment of the present invention. FIGS. 16 and 20 are SEM photos taken from a point 1 of FIG. 15, and FIGS. 17 and 21 are SEM photos taken from a point 2 of FIG. 15, FIGS. 18 and 22 are SEM photos taken from a point 3 of FIG. 15, and FIGS. 19 and 23 are SEM photos taken from a point 4 of FIG. 15. In the two cases, the SEM photos are taken after the surface of the photo mask is intentionally charged-up at a certain electric charge level, for example, at −10V, by using an ionizer according to the present invention. Also, the photo mask 100′ is installed on the sample holder so that the pin of the sample holder is in contact with the chrome patterns formed on the circumference region 160. A location nearest to a circumference region of a pattern region 130 is selected by the measured points 1, 2, 3 and 4 so that a difference between ground and non-ground of the photo mask 100′ and the sample holder is estimated.

FIGS. 16 through 19 are SEM photos taken not from actual patterns formed by a pattern shift phenomenon, but from another adjacent patterns. In contrast, FIGS. 20 through 23 clearly show actual pattern shapes, and this means that the pattern shift phenomenon is prevented where the ground pin is insulated from the surface of the photo mask.

According to the present invention, the surface of the sample is intentionally provided with electric charge in the form of ions, for example, before SEM photographing begins. As a result, the primary electrons of the beam emitted by the SEM are not deflected as they near the surface of the sample. Thus, the pre-charging of the surface of the sample facilitates the initial focusing of the SEM, and suppresses the pattern shift phenomenon.

That is, the pattern shift phenomenon does not occur, or the duration thereof, i.e., time required to capture stable images, is significantly reduced. Thus, the present invention facilitates significant improvements in the efficiency of inspection processes requiring much SEM photographing, such as the inspection process used to analyze a photo mask. That is, the present invention helps to realize higher productivity in the process of manufacturing semiconductor devices.

Also, where the surface of the sample is insulated from the sample holder, that is, is not electrically grounded, the pattern shift phenomenon or defects in focusing can be further prevented. As this happens, the SEM photos can be exactly and quickly taken from patterns on all regions of the surface of the sample, such as the photo mask.

Although the present invention has been particularly shown and described with reference to the preferred embodiments thereof, various changes to the form and detailed aspects of the invention will become apparent to those skilled in the art. All such changes are seen to be within the true spirit and scope of the invention as defined by the appended claims.

What is claimed is:

1. A method of capturing scanning electron microscope (SEM) images of a surface of a sample, the method comprising the steps of:
scanning the surface of the sample with a primary beam of electrons, whereby the primary beam of electrons causes secondary electrons to be emitted from the surface of the sample;
before the surface of the sample is scanned by the primary beam of electrons that causes secondary electrons to be emitted from the surface of the sample, intentionally electrically charging the surface of the sample to increase the uniformity of the distribution of charge on the surface and thereby reduce the tendency of the electrons of the primary beam to deflect due to electrical attraction or repulsion as they approach the surface;
capturing secondary electrons emitted from the surface of the sample;
converting the captured secondary electrons into a signal; and
processing the signal to produce an image of the surface of the sample scanned by the primary beam of electrons.

2. The method of capturing SEM images according to claim 1, wherein said intentional charging of the surface of the sample comprises directing ions onto the surface of the sample.

3. The method of capturing SEM images according to claim 1, wherein said intentional charging of the surface of the sample comprises directing electrons onto the surface of the sample.

4. The method of capturing SEM images according to claim 1, wherein said intentional charging of the surface of the sample comprises providing the surface of the sample with a net negative charge.

5. The method of capturing SEM images according to claim 1, wherein said intentional charging of the surface of the sample comprises providing the surface of the sample with a net positive charge.

6. The method of capturing SEM images according to claim 1, wherein said intentional charging of the surface of the sample comprises dedicating an electrical power source to the sample, producing electrical charge using the electrical power source, and directing the charge onto the surface of the sample.

7. The method of capturing SEM images according to claim 1, and further comprising measuring the level of charge at the surface of the sample, and wherein said intentional charging is carried out until the level of charge reaches a predetermined level.

8. The method of capturing SEM images according to claim 1, wherein the surface of the sample is not electrically grounded.

9. A method of capturing scanning electron microscope (SEM) images of the surface of a photo mask used in the process of manufacturing a semiconductor device, the method comprising the steps of:
providing a sample comprising a patterned electrical conductor isolated by an electrical insulator;
scanning the surface of the sample with a primary beam of electrons, whereby the primary beam of electrons causes secondary electrons to be emitted from the surface of the sample;
before the surface of the sample is scanned by a primary beam of electrons that causes secondary electrons to be emitted from the surface of the sample, intentionally electrically charging the surface of the sample to increase the uniformity of the distribution of charge on the surface and thereby reduce the tendency of the electrons of the primary beam to deflect due to electrical attraction or repulsion as they approach the surface;
capturing secondary electrons emitted from the surface of the sample;
converting the captured secondary electrons into a signal; and
processing the signal to produce an image of the conductor.

10. The method of capturing SEM images according to claim 9, wherein said intentional charging of the surface of the sample comprises directing ions onto the surface of the sample.

11. The method of capturing SEM images according to claim 9, wherein said intentional charging of the surface of the sample comprises directing electrons onto the surface of the sample.

12. The method of capturing SEM images according to claim 9, wherein said intentional charging of the surface of the sample comprises providing the surface of the sample with a net negative charge.

13. The method of capturing SEM images according to claim 9, wherein said intentional charging of the surface of the sample comprises providing the surface of the sample with a net positive charge.

14. The method of capturing SEM images according to claim 9, wherein said intentional charging of the surface of the sample comprises dedicating an electrical power source to the sample, producing electrical charge using the electrical power source, and directing the charge onto the surface of the sample.

15. The method of capturing SEM images according to claim 9, and further comprising measuring the level of charge at the surface of the sample, and wherein said intentional charging is carried out until the level of charge reaches a predetermined level.

16. The method of claim 9, wherein the surface of the sample is electrically insulated from ground.

17. A scanning electron microscope (SEM) apparatus for capturing images of a sample, comprising:
an image photographing unit including a chamber, an electron beam unit disposed in said chamber and operative to produce a beam of primary electrons and scans the beam across the surface of a sample loaded in the chamber, a secondary electron detector disposed in said chamber and operative to detect secondary electrons emitted from the sample and produce a signal representative of the image of the surface from which the secondary electrons were emitted, and a processor operatively connected to said secondary electron detector so as to convert the signal into the image of the surface from which the secondary electrons were emitted; and
a sample processing unit connected to said image photographing unit, said sample processing unit including an electric charge generator operative to generate electric charge and direct the charge onto the surface of the sample.

18. The scanning electron microscope (SEM) apparatus according to claim 17, wherein said electric charge generator is an ionizer that produces ions.

19. The scanning electron microscope (SEM) apparatus according to claim 17, wherein the sample processing unit further includes an auxiliary chamber, and said electric charge generator is an electron gun disposed in said auxiliary chamber.

20. The scanning electron microscope (SEM) apparatus according to claim 17, and further comprising a loader operative to move a sample from said sample processing unit into the chamber of said image photographing unit.
